(19) United States
(12) Patent Application Publication
(10) Pub. No.: US 2025/0124899 A1
(43) Pub. Date: Apr. 17, 2025

(54) DROP CHIME SET

(71) Applicant: Mindee K. Mohr, North Platte, NE (US)

(72) Inventor: Mindee K. Mohr, North Platte, NE (US)

(21) Appl. No.: 18/918,875

(22) Filed: Oct. 17, 2024

Related U.S. Application Data
(60) Provisional application No. 63/590,954, filed on Oct. 17, 2023.

(51) Int. Cl. G10D 13/08; G09B 15/00; G10D 13/10

(52) U.S. Cl. CPC G10D 13/08; G09B 15/00; G10D 13/10

(57) ABSTRACT

A drop chime set comprising a plurality of drop chimes configured to be individually dropped onto a hard surface in a specific sequence to play the melody of a song (tune). In embodiments, individual drop chimes of the drop chime set may be tuned to emit a sound having a specific note (frequency and wavelength) and may be provided with indicia such as a number, letter, or the like, to indicate its position within the sequence of drop chimes. To play a song, the drop chimes are dropped in sequence, for example, by multiple users.

### CROSS-REFERENCE TO RELATED APPLICATIONS

The present application claims the benefit, under 35 U.S.C. § 119 (e), of U.S. Provisional Patent Application Ser. No. 63/590,954, filed Oct. 17, 2023, and titled “DROP CHIME SET.” U.S. Provisional Patent Application Ser. No. 63/590,954 is herein incorporated by reference in its entirety.

### BACKGROUND

Music-rich classroom environments help children practice the listening and verbal skills necessary for understanding and communicating through spoken language. Music is also a fun activity for children and can be used to celebrate special events such as birthdays or holidays.

### DRAWINGS

The Detailed Description is described with reference to the accompanying figures. In the figures, the use of the same reference numbers in different instances in the description and the figures may indicate similar or identical items.

FIG. 1 is an isometric view illustrating a drop chime set comprising a plurality of drop chimes in accordance with an embodiment of the present disclosure.

FIG. 2 is an isometric view illustrating an example drop chime of the drop chime set shown in FIG. 1 in accordance with embodiments of the present disclosure.

FIGS. 3A through 3E are isometric views illustrating drop chimes having a variety of cross-sections in accordance with embodiments of the present disclosure.

FIG. 4 is a cross-sectional side elevational view illustrating a drop chime equipped with a clapper assembly in accordance with an embodiment of the present disclosure.

FIG. 5 is a flow diagram illustrating a method for playing drop chimes in accordance with an embodiment of the present disclosure.

FIG. 6 is a schematic diagram illustrating the playing of a melody employing the method shown in FIG. 5, using a drop chime set, such as the drop chime set shown in FIG. 1, in accordance with embodiments of the present disclosure.

### DETAILED DESCRIPTION

### Overview

The present disclosure is directed, at least in part, to a drop chime set comprising a plurality of drop chimes configured to be individually dropped onto a hard surface in a specific sequence to play the melody of a song (tune). In embodiments, individual drop chimes of the drop chime set may be tuned to emit a sound having a specific note (frequency and wavelength) and may be provided with indicia such as a number, note, letter, or the like, to indicate its position within the sequence of drop chimes. To play a song, the drop chimes are dropped in sequence, for example, by multiple users. The drop chimes may be dropped individually. However, it is contemplated that two or more drop chimes may be dropped simultaneously, for example, to play a chord.

### Example Embodiments

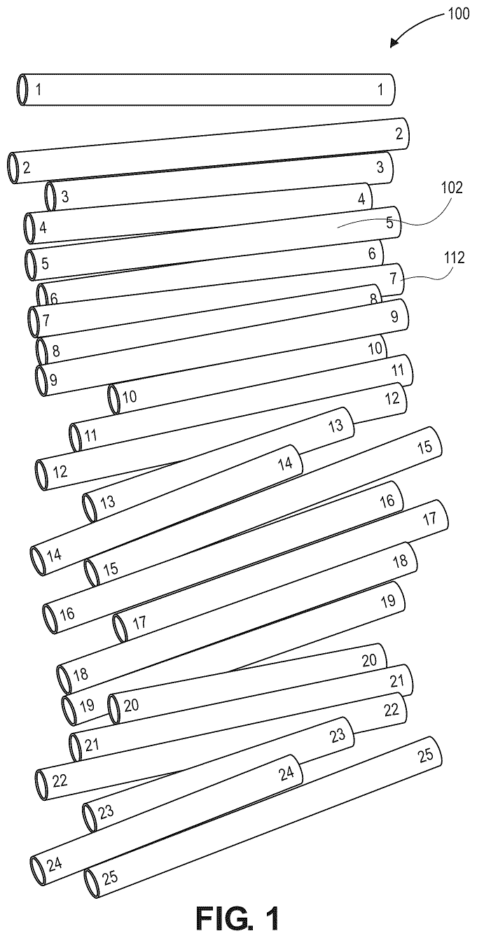

Referring to FIG. 1, an example drop chime set is 100 is disclosed. The drop chime set 100 is comprised of a plurality of drop chimes 102 configured to play a melody (e.g., a song or tune) when dropped to a hard surface, such as a floor (not shown) in a predetermined sequence. In embodiments, each drop chime 102 comprises a short tube having an outer wall 104 defining a hollow interior volume 106 and having a first end 108 and a second end 110. The outer wall 104 may have a length (“L”) between the first end 108 and the second end 110, width (diameter “D”), wall 104 thickness (“T”), or the like, that causes the drop chime 102 to play (emit) a specific note (tone or sound having a predetermined wavelength and frequency) when dropped to the hard surface.

In embodiments, the drop chime set 100 comprises drop chimes 102 that are configured to play the various notes of a desired melody. For example, drop chimes 102 of the drop chime set 100 may have differing lengths (“L”), widths (diameter “D”), wall 104 thicknesses (“T”), or the like, that cause the respective drop chimes 102 to play (emit) different notes (tone or sound having a predetermined wavelength and frequency) when dropped to the hard surface in a predetermined sequence. Moreover, the drop chime set 100 may include multiple drop chimes 102 that are configured to play (emit) the same note as required to play a desired melody having multiple instances of one or more notes. The drop chimes 102 may be dropped individually. However, it is contemplated that two or more drop chimes 102 may be dropped simultaneously, for example, to play a chord.

In embodiments, the drop chime set 100 includes a specific number of drop chimes 102 preconfigured to play the notes of specific melody when dropped on a hard surface such as the floor. In such embodiments, the drop chime set 100 contains the number of drop chimes 102 required to play the desired song such that there are no extra chimes of notes not used by the song. For example, a drop chime set 100 may be comprised of twenty-one (21) drop chimes 102 that play the musical notes of the song “Happy Birthday (Anniversary)”/“Good Morning to You!” The drop chimes 102 of this drop chime set 100 are configured (e.g., formed (cast, molded, cut etc. and/or tuned) with different lengths so that the drop chimes 102 play (emit) the different notes of the song. It will be appreciated that, in other embodiments, drop chime sets having more or less chimes may be made to play the melodies of other songs/tunes. In such embodiments, the drop chime set 100 may have multiple drop chimes 102 configured to play (emit) the specific notes required by the song to be played.

In other embodiments, the drop chime set 100 includes a sufficient number of drop chimes 102 to play the melodies of a variety of songs. In such embodiments, the drop chime set 100 may have a sufficient quantity of drop chimes 102 configured to play (emit) various notes within a range or scale of notes so that the drop chime set 100 includes multiple drop chimes 102 configured to play (emit) each note. In such embodiments, a user, such as a music director, teacher, or the like, may select drop chimes 100 from the drop chime set and then order the selected drop chimes to play the melody of the desired song when the drop chimes 102 are thereafter dropped.

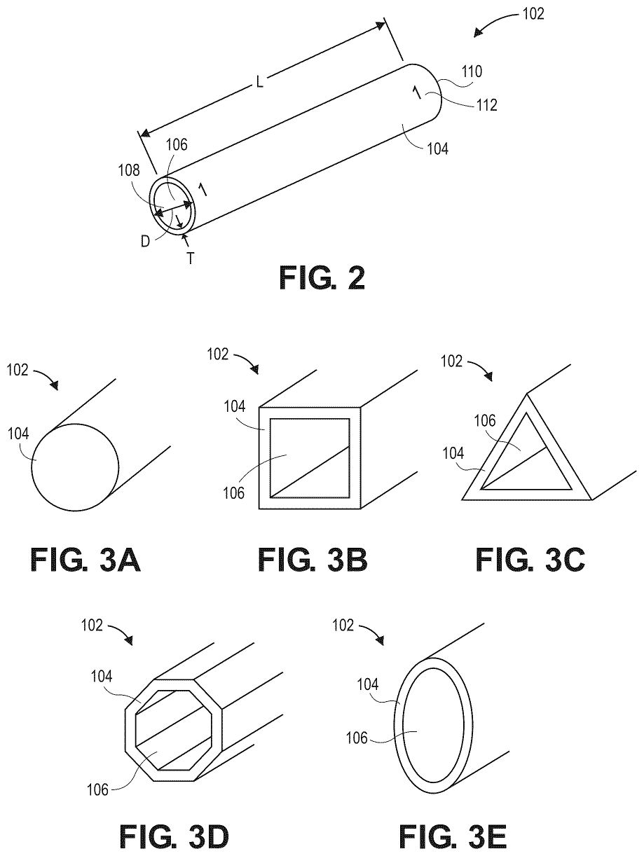

As shown in FIGS. 1 and 2, the drop chimes 102 of the drop chime set 100 are provided with indicia 112 indicating the position of the drop chime 102 within the pre-determined sequence of the melody to be played. In embodiments, these indicia may comprise numbers (shown), letters (e.g., A, B, C, etc.), musical notes (e.g., Ab, C, B #, etc.), pictographs, or the like. For example, in the embodiment comprising a drop chime set 100 having twenty-five (25) drop chimes 102 that play the musical notes of the song “Happy Birthday (Anniversary)”/“Good Morning to You!”, the drop chimes include indicia 112 comprised of numbers such that the drop chimes 102 are numbered in order from 1 to 21 (see FIG. 1). When the drop chimes 102 are dropped in the numbered sequence (e.g. chime “1”, chime “2”, chime “3”, and so forth), the drop chime set 100 plays the melody of the song, i.e., “Happy Birthday (Anniversary)”/“Good Morning to You!”

In embodiments, the drop chimes 102 of the drop chime set 100 can be unpainted or untinted (e.g., a steel galvanized color). In other embodiments, the drop chimes 102 can be colored, e.g., painted, tinted, chromed, or the like or made of colored metal, plastic, or wood. In embodiments, the drop chimes can be color coded to specific notes or position in the drop sequence (e.g., rainbow colored, colors corresponding to specific notes, etc.).

As shown in FIGS. 1 and 2, drop chimes 102 of the drop chime set 100 comprise cylindrical tubes 104 formed of metal (e.g., steel, aluminum, brass, etc.) having a circular cross section and defining an interior volume 106 having a cylindrical shape. For example, in one embodiment, the drop chimes 102 may be manufactured from EMT conduit pipe (or similar metal pipe) that is cut to various lengths and tuned (e.g., ground, or polished) to play different notes. However, it is contemplated that drop chimes 102 of the drop chime set 100 may be made of materials other than metal such as wood, plastic, composite, and the like. Moreover, it is contemplated that the drop chime set 100 can comprise multiple drop chimes 102 wherein respective ones of the drop chimes 102 are made of varied materials (e.g., metal, wood, plastic, composite, etc.)

As shown in FIGS. 3A through 3E, the drop chimes 102 may, in embodiments, have cross-sections other than circular and need not be hollow. For example, FIG. 3A illustrates a drop chime 102 comprising a solid tube (rod) 104; FIG. 3B illustrates a drop chime 102 comprising a hollow tube 104 having a square cross-section defining hollow interior volume 106 having a rectangular prism shape; FIG. 3C illustrates a drop chime 102 comprising a hollow tube 104 having a triangular cross-section defining a hollow interior volume 106 having a triangular prism shape; FIG. 3D illustrates a drop chime 102 comprising a hollow tube 104 having a octagonal cross-section defining a hollow interior volume 106 having a octagonal prism shape; and FIG. 3E illustrates a drop chime 102 comprising a hollow tube 104 having an oval cross-section defining a hollow interior volume 106 having a oval cylinder shape. Drop chimes 102 comprising solid or hollow tubes 104 having other cross-sections are possible. Further, it is contemplated that the drop chime set 100 can comprise multiple drop chimes 102, wherein respective ones of the drop chimes 102 have different cross-sections, with respective ones of the drop chimes 102 made of varied materials (e.g., metal, wood, plastic, composite, etc.). Thus, in an example embodiment, a drop chime set 100 may, for example, comprise drop chimes 102 formed of metal having a hollow circular cross section, drop chimes 102 formed of wood having a hollow square cross section, and drop chimes formed of a solid plastic having a triangular cross-section.

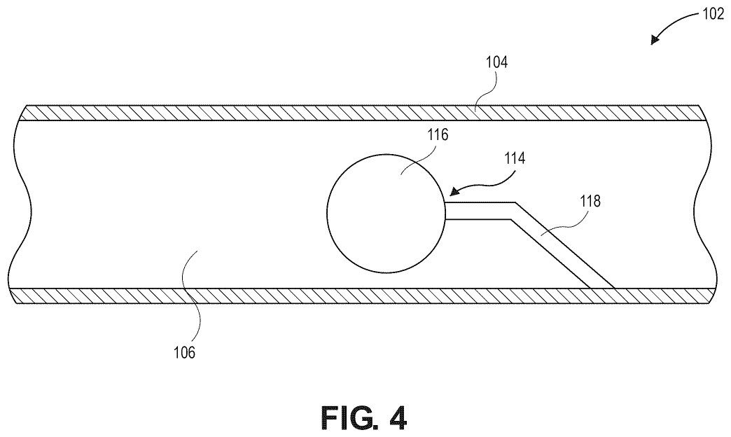

FIG. 4 illustrates a drop chime 102 of the drop chime set 100 that includes a clapper assembly 114 disposed within the interior volume 106 of the hollow tube 104. In such embodiments, the clapper assembly 114 permits the drop chime 114 to produce unique musical qualities such as overtones, or the like. As shown, the clapper assembly 114 comprises a clapper (striker) 116 mounted to the interior of the hollow tube via a hinge spring 118. In embodiments, the hinge spring 118 is sufficiently rigid to hold the clapper 116 away from the hollow tube 104 until the drop chime 102 strikes a hard surface after being dropped, whereupon the hinge spring 118 allows the clapper 116 to move back and forth in a single direction to strike the interior of the hollow tube 104. The hinge spring 118 may thereafter hold the clapper 116 away from the interior of the hollow tube 104 to allow the drop chime 102 to ring freely. In embodiments, all drop chimes 102 of the drop chime set 100 may be provided with clapper assemblies 114. In other embodiments, only selected drop chimes 102 of the drop chime set 100 may be provided with clapper assemblies 114. Moreover, clapper assemblies 114 may be provided for drop chimes 102 employing hollow tubes 104 of any cross-section (e.g., circular, square, triangular, oval, hexagonal, etc.) and formed of any material (e.g., metal, wood, plastic, composite, etc.).

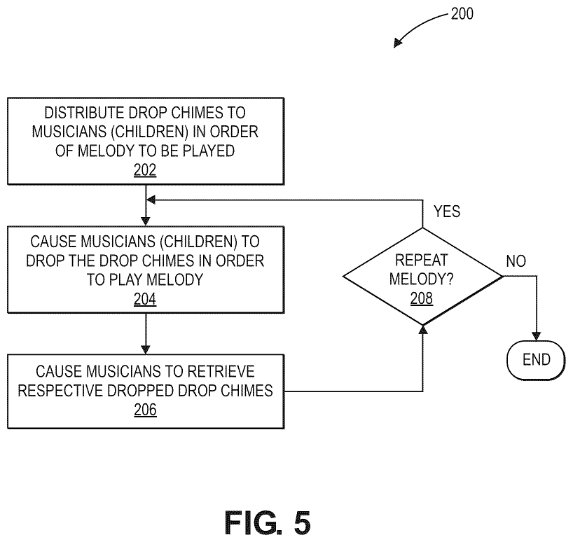

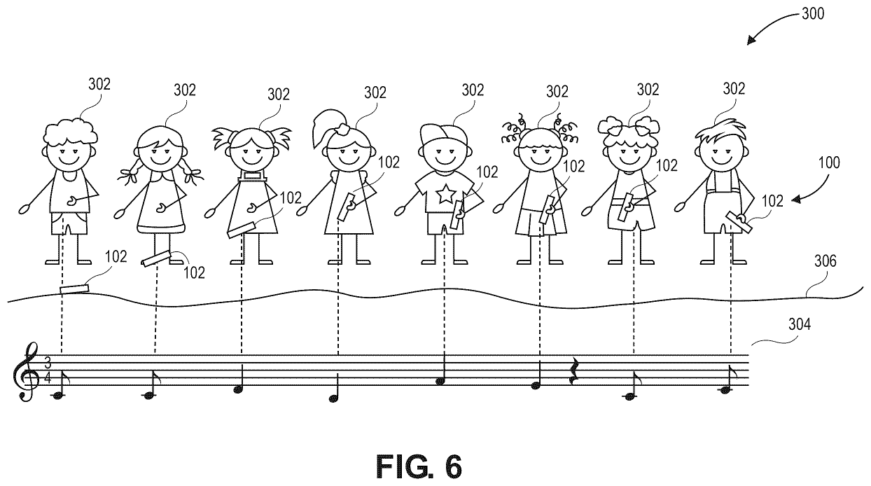

FIGS. 5 and 6 illustrate a method 200 for playing drop chimes 102 of a drop chime set 100 in accordance with the present disclosure. The method 200 may, for example, be employed by a user such as a music director, teacher, or the like for teaching a melody to a group of users such as, for example, a class of school children 300.

In embodiments, the method 200 comprises distributing a plurality of drop chimes 102 of a drop chime set 100 to the group of children 300 so that each child 302 in the group of children 300 is provided with at least on drop chime 102 of the drop chime set 100. As discussed herein in the description of FIGS. 1 through 4, each drop chime 102 of the drop chime set 100 is configured to play (emit) a sound having a musical note when dropped onto a hard surface 304 such as a floor or ground surface, so that when dropped in a pre-determined sequence the drop chimes 102 play a desired melody (e.g., “Happy Birthday (Anniversary)”/“Good Morning to You!”) 306 (Block 202).

Each child 302 in the group of children 300 is then caused (directed or instructed) to drop the drop chime(s) 102 distributed to him/her in the predetermined sequence so that the desired melody 306 is played. (Block 204).

Each child 302 of the group of children 300 may then be caused (directed or instructed) to retrieve the drop chime(s) provided to that child 302 (Block 206) and thereafter to again drop the drop chime(s) 102 in the predetermined sequence if the desired melody 306 is to be played again (“YES” at Decision Block 208). Alternately, the group of children 300 may be instructed to hold the drop chimes 102 if the melody 306 is not to be played further (“NO” at Decision Block 208)

In embodiments, individuals (children 302 within the group of children 300) need not be able to read music or have any musical training to use the drop chime set 100. For example, as shown in FIG. 1, the individual drop chimes 102 of the drop chime set may be provided with indicia 114 numbering the drop chimes 102 in the order to be played. A group of users (children 302) can stand in a line or circle to play the melody. Individuals (children 302) withing the group can hold/drop more than one drop chime 102 or divide into groups as desired.

As described herein, the drop chime set 100 can be used by music directors or teachers in a classroom setting to teach music, music theory, and the responsibilities of playing an instrument to young children. The drop chimes 100 may also be used by teachers as a fun activity for their students to promote teamwork among the students. Since drop chimes 102 of the drop chime set 100 are played individually rather than in unison, each student is thus only responsible for playing the drop chimes 102 assigned to him or her.

### CONCLUSION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

1. A drop chime set, comprising:
a first drop chime, the first drop chime comprising a hollow tube having an outer wall including a first length, a first width and a first thickness, wherein at least one of the first length, the first width, or the first thickness is configured to cause the first drop chime to emit a first sound corresponding to a first musical note when the first drop chime is dropped onto a surface; and
a second drop chime, the second drop chime comprising a hollow tube having an outer wall including a second length, a second width and a second thickness, wherein at least one of second length, the second width, or the second thickness is configured to cause the second drop chime to emit a second sound corresponding to a second musical note when the second drop chime is dropped onto the surface,
wherein the first drop chime and the second drop chime are configured to be dropped in a pre-determined sequence so that the first and second notes form a part of a desired melody.

2. The drop chime set as recited in claim 1, wherein respective ones of the first outer wall and the second outer wall comprise a circular cross-section and the first width comprises a first diameter of the first tube and the second width comprises a second diameter of the second tube.

3. The drop chime set as recited in claim 1, wherein respective ones of the first outer wall and the second outer wall comprise a polygonal cross section.

4. The drop chime set as recited in claim 3, wherein the polygonal cross section is one of square, rectangular, hexagonal, or octagonal.

5. The drop chime set as recited in claim 1, wherein respective ones of the first outer wall and the second outer wall comprise an oval cross section.

6. The drop chime set as recited in claim 1, wherein respective ones of the first drop chime and the second drop chime comprise indicia indicating the position of that drop chime within the pre-determined sequence.

7. The drop chime set as recited in claim 6, wherein the indicia comprise at least one of numbers, letters, or notes.

8. The drop chime set as recited in claim 7, wherein respective ones of the first drop chime and the second drop chime have a distinctive color indicating at least one of a note or the position of that drop chime within the pre-determined sequence.

9. A drop chime set, comprising:
a plurality of drop chimes;
wherein each of the plurality of drop chimes is configured to emit a sound having a musical note when dropped onto a hard surface such that when dropped in a pre-determined sequence the drop chimes play a desired melody.

10. The drop chime set as recited in claim 9, wherein at least one of the drop chimes comprises a hollow tube having an outer wall.

11. The drop chime set as recited in claim 10, wherein the outer wall comprises a circular cross-section.

12. The drop chime set as recited in claim 10, wherein the outer wall comprises a polygonal cross section.

13. The drop chime set as recited in claim 12, wherein the polygonal cross section is one of square, rectangular, hexagonal, or octagonal.

14. The drop chime set as recited in claim 10, wherein the outer wall comprises an oval cross section.

15. The drop chime set as recited in claim 9, wherein each of the plurality of drop chimes comprises indicia indicating the position of the drop chime within the pre-determined sequence.

16. The drop chime set as recited in claim 15, wherein the indicia comprise at least one of numbers, letters, or notes.

17. The drop chime set as recited in claim 9, wherein one or more drop chimes are colored.

18. The drop chime set as recited in claim 17, wherein respective ones of the drop chimes have a distinctive color indicating at least one of a note or the position of the drop chime within the pre-determined sequence.

19. A method of using a drop chime set for teaching a melody to a group of children, the method comprising:
distributing a plurality of drop chimes to the group of children so that each child in the group of children is provided with at least on drop chime of the plurality of drop chimes, wherein each drop chime of the plurality of drop chimes is configured to emit a sound having a musical note when dropped onto a hard surface such that when dropped in a pre-determined sequence the drop chimes play a desired melody; and
causing each child in the group of children to drop the provided at least one drop chime in the predetermined sequence to play the desired melody.

20. The method as recited in claim 19, further comprising:
causing each child of the group of children to retrieve the respective at lease on drop chime provided to that child and thereafter to again drop the provided at least one drop chime in the predetermined sequence to play the desired melody again.
